(19) United States
(12) Patent Application Publication
(10) Pub. No.: US 2004/0011719 A1
(43) Pub. Date: Jan. 22, 2004

(54) Filter press

(76) Inventor: Bernd Boehnke, Eschweiler (DE)

Correspondence Address: FASSE PATENT ATTORNEYS, P.A., P.O. BOX 726, HAMPDEN, ME, 04444-0726, US

(21) Appl. No.: 10/432,910

(22) PCT Filed: Nov. 19, 2001
(86) PCT No.: PCT/EP01/13355

(30) Foreign Application Priority Data
Nov. 29, 2000 (DE) 100 59 267.8

(51) Int. Cl. B01D 25/172

(52) U.S. Cl. 210/230; 210/231

(57) ABSTRACT

A filter press (1) for filtering suspensions is provided with a package of plate-like filter elements (5) which in a filtration position can be pressed sealingly against one another in a parallel arrangement. Thereby the filter elements (5) enclose in pairs a filter chamber which is delimited at least on one side by a planar filter medium. Furthermore, the filter elements (5) are movable to a discharging position in which adjacent filter elements (5) have a distance from one another which allows the removal of the filter cake from the filter chamber. In order to reduce the overall height of such a filter press (1) or to increase the filter surface area with unchanged overall height, it is proposed that the filter elements (5) are alternatingly inclined towards one another in the opposite direction in the discharging position, so that the distance between adjacent filter elements (5) increases in the discharging direction of the filter cake.

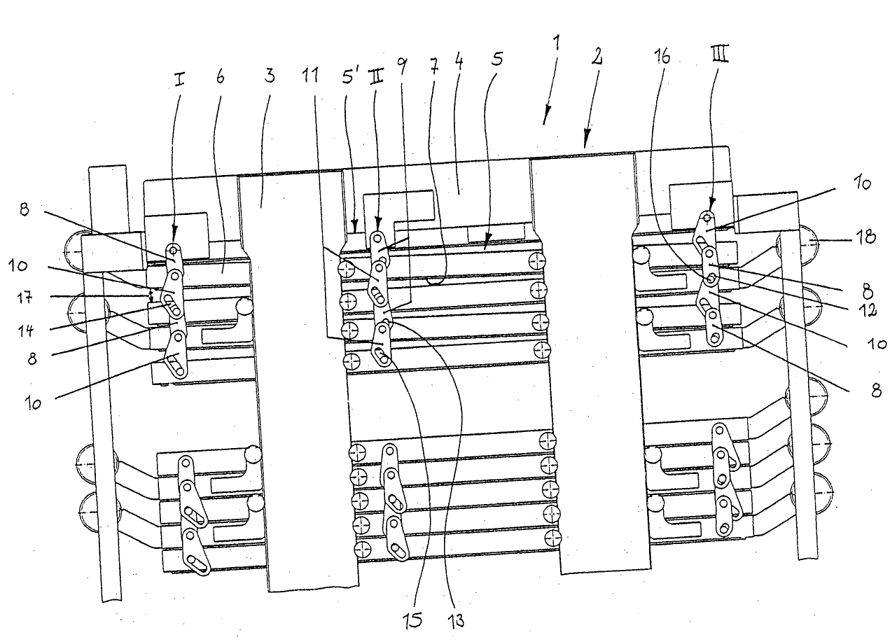

The invention relates to a filter press for filtering suspensions, with a package of plate-like filter elements which can be pressed sealingly against one another in a parallel arrangement in a filtration position and thereby enclose in pairs, a filter chamber which is delimited at least on one side by a planar filter medium, with the filter elements being movable to a discharging position in which adjacent filter elements have a distance from one another which allows the removal of the filter cake from the filter chambers.

Such filter presses are generally known as so-called automatic press filters. DE-OS 19 61 061 describes for example, a suspending apparatus for horizontal filter plates which are disposed horizontally above one another in an upright filter press. For opening, the filter plates are moved in the perpendicular direction upwardly and/or downwardly in order to bring all filter plates successively to the same distance to one another. The filter medium is arranged as an endless filter belt guided in a zig-zag manner through the package of plates on which the filter cake has accumulated at the end of the filtration process. As a result of an advancing movement of the filter belt, the filter cake adhering to the filter cloth is removed from the adjacent filter chambers in a respective opposite direction. The coupling of adjacent filter plates occurs in the known filter presses by means of hook-like connecting brackets which are held on carrying lugs projecting laterally beyond the filter plates and can be brought into engagement with the carrying lugs of the respective filter plate disposed beneath.

Even if such filter presses have proven their worth over many years, a certain disadvantage can be seen in the fact that the space required during the transfer of the package of plates to the discharging position is relatively large, which is especially the case for a large number of filter plates, i.e. also a large sum of individual discharging distances.

The invention is therefore based on the object of providing a filter press for the filtration of suspensions in which the space needed during the discharging state of the filter plate package is reduced and a larger filter surface area is available while the need for space remains the same.

Based on a filter press of the kind mentioned above, this object is achieved in accordance with the invention in such a way that the filter elements are alternatingly inclined towards one another in the opposite direction in the discharging position, so that the distance between adjacent filter elements increases in the discharging direction of the filter cake.

In the filter press in accordance with the invention, the need for space in the discharging position is thus reduced to a not inconsiderable extent, because the distance of adjacent filter elements on the side on which the filter medium enters the space between the filter plates is substantially smaller than the distance necessary for discharging the filter cake of a specific thickness on the opposite side of the filter plate on which the filter cake is usually discharged with the help of the filter medium which is moved there out of the chamber. Since the filter elements are provided alternatingly with an opposite inclination with respect to one another, the filter plate package is also provided in the discharging position with an overall cuboid and thus vertical stacking. Especially in filter presses with a large number of filter plates, the overall height required in the discharging position can be reduced and in the case of maintaining a given maximum possible overall height it is possible to increase the number of filter plates to be housed and thus the useful filter surface area.

According to an embodiment of the filter press in accordance with the invention, it is proposed that the distance between the filter elements on the side averted from the outlet of the filter cake is just about as large so that the filter medium can be moved through the obtained gap. The required overall height is thus further reduced, with the gap just about being dimensioned in its height in such a way that wear and tear of the filter cloth is prevented by any unnecessary contact with the filter elements. A value suitable for practical application is approx. 5 mm.

A further development of the invention is that the filter elements are each composed of a filter plate and a frame encompassing the same and carrying deflection devices for the web-shaped filter medium, with the filter plates being held in the frame with play in such a way that different heat expansions between the filter plate and the frame can be compensated. In this case the filter plates and the frame can be made of different materials with different coefficients of thermal expansion. Preferably, the component responsible as the frame for the strength of the filter plate arrangement and the precision of the guidance of the filter medium is made of steel and the filter plate, for reasons of weight, is made of plastic, e.g. polypropylene. The coupling of the filter elements is carried out in this case through the coupling of the frames with one another, whereas the filter plates are held within the frame by way of suitable connecting members.

A preferred possibility to couple the filter elements with one another is that adjacent filter elements are mutually coupled by way of connecting brackets, with the connecting brackets being provided with a groove each on the side averted from the outlet of the filter cloth, the length of which groove only slightly exceeds the diameter of a journal of an adjacent filter element as received by said groove. These coupling elements in form of connecting brackets which are loaded with a tensile force allow choosing differently large distances of the filter plates at different locations in a simple manner. Moreover, in such an arrangement the efforts required for redesigning known filter presses with a continually parallel arrangement of the filter elements with respect to one another are particularly little.

In order to also ensure a secure support in the discharged state in the case of filter elements with a large extension in the conveying direction of the filter medium, it is provided that three or more connecting brackets are disposed preferably at the same distance from one another along the length of each filter element, which connecting brackets are each disposed with the connecting brackets of the adjacent filter elements in vertical rows, with each journal fastened to a filter element, on the one hand, engaging in a groove of a connecting bracket which is held in the filter element disposed above and, on the other hand, forming a bearing journal for the connecting bracket for coupling the filter element disposed underneath.

A scaled, i.e. inclined overlapping, arrangement of the connecting brackets disposed above one another can be avoided in that the connecting brackets of one row are disposed alternatingly in two parallel vertical planes extending parallel to the discharging direction of the filter cake.

The invention is now explained in closer detail by reference to an embodiment of a filter press shown in the drawing. The drawing shows a side view of a filter press in the form of a so-called automatic press filter in which five upper filter elements in the discharging position are shown, whereas five filter elements disposed underneath are situated in the closed position.

The filter press 1 only shown schematically in a sectional view is provided with a press frame 2 consisting of four vertically arranged connection pieces 3 (the two rear connection pieces 3 are not shown) and two horizontally extending longitudinal beams 4 (the rear longitudinal beam 4 is also not shown) as well as non-visible crossbeams extending vertically to the plane of the drawing. Within said frame which is held on respective foundations there is a package made up of a plurality of superimposed plate-like filter elements 5. The filter elements 5 each consist of a rectangular circumferential frame 6 of which only one longitudinal side is visible and a filter plate 7 arranged therein, of which only the lower edge strip projecting in the vertical direction over frame 6 is visible.

In the filtration position, all filter elements 5 are pressed against one another with the help of a hydraulic closing device (not shown) which is disposed at the lower end of the filter plate package, so that the filter chambers disposed between adjacent filter plates are sealed off and the filtration process can proceed therein. For this purpose the pressurized suspension is introduced into the filter chambers by means of feed lines (not shown). Under separation of the particles disposed in the suspension, the liquid, the so-called filtrate, passes through the filter medium and leaves the press 1 via filtrate collecting lines (also not shown in closer detail). Once a respective quantity of solids has been separated and filter cake has been formed, the package of plates is relieved by retracting the hydraulic closing device.

The upper filter element 5′ is held fixedly to the frame, whereas the further filter elements 5 (in the present case on the circumferential frame 6) are mutually coupled by way of connecting brackets 8, 9, 10 and 11. Whereas the connecting brackets 8 comprise a groove 12 which is merely slightly longer than the diameter of pin 16, which is fastened to the respective frame 6 disposed underneath, the groove 14 in connecting bracket 10 is provided with such a length that in the zone of the connecting bracket 10 such a distance 17 occurs between two adjacent filter elements 5 that the filter cake can be discharged through the obtained gap together with the filter cloth (not shown) which is guided by deflecting rollers.

In the illustrated filter press 1, adjacent filter elements 5 are thus provided in the discharging position alternatingly with an opposite inclination, so that wedge-like intermediate spaces between the filter plates 6 are obtained which comprise on the side of the connecting brackets 8 a minimum distance for the passage of the filter cloth as friction-free as possible and assume on the side opposite to the cake discharge a sufficiently large distance which corresponds at least to the filter cake thickness.

The connecting brackets 9 and 11 which are disposed alternatingly in the middle row II are provided with grooves 13 and 15 which are dimensioned in such a way that they produce an additional support of the filter elements 5 in the middle region. In the rows I and III, which are disposed at the edges, the connecting brackets 8 and 10 alternate, so that, in adaptation to the zig-zag-like course of the filter cloth, the distance between adjacent filter elements 5 is respectively differently large.

In all rows I, II and III, the connecting brackets 8 and 10 or 9 and 11 respectively are disposed in two offset planes extending parallel with respect to one another. In row I, the connecting brackets 10 are disposed in a front plane and the connecting brackets 8 in a rear plane. In row III the situation is completely reversed. In the middle row II the connecting brackets 11 are disposed in a front plane and the connecting brackets 9 in a rear plane.

1. A filter press (1) for filtering suspensions, with a package of plate-like filter elements (5) which in a filtration position can be pressed sealingly against one another in a parallel arrangement and thereby enclose in pairs a filter chamber which is delimited at least on one side by a planar filter medium, with the filter elements (5) being movable to a discharging position in which adjacent filter elements (5) have a distance from one another which allows the removal of the filter cake from the filter chambers, characterized in that the filter elements (5) are alternatingly inclined towards one another in the opposite direction in the discharging position, so that the distance between adjacent filter elements (5) increases in the discharging direction of the filter cake.

2. A filter press as claimed in claim 1, characterized in that the distance between the filter elements (5) on the side averted from the outlet of the filter cake is just large enough that the filter medium can be moved through the obtained gap.

3. A filter press as claimed in claim 1 or 2, characterized in that the filter elements (5) are each composed of a filter plate (7) and a frame (6) enclosing the same and carrying the deflection devices (18) for the web-like filter medium, with the filter plate (7) being held with play in the frame (6) in such a way that different heat expansions between the filter plate (7) and the frame (6) can be compensated.

4. A filter press as claimed in one of the claims 1 to 3, characterized in that adjacent filter elements (5) are mutually coupled by way of connecting brackets (8, 9, 10, 11), with the connecting brackets (8) being provided with a groove (12) each on the side of the filter elements (5) averted from the outlet of the filter cloth, the length of which groove only slightly exceeds the diameter of a journal (16) of an adjacent filter element (5) as received by said groove.

5. A filter press as claimed in claim 4, characterized in that three or more connecting brackets (8, 9, 10, 11) are disposed preferably at the same distance from one another along the length of each filter element (5), which connecting brackets are each disposed with the connecting brackets (8, 9, 10, 11) of the adjacent filter elements (5) in vertical rows (I, II, III), with each journal (16) fastened to a filter element (5), on the one hand, engaging in a groove (12, 13, 14, 15) of a connecting bracket (8, 9, 10, 11) which is held in the filter element (5) disposed above and, on the other hand, forming a bearing journal for the connecting bracket (8, 9, 10, 11) for coupling the filter element (5) disposed underneath.

6. A filter element as claimed in claim 5, characterized in that the connecting brackets (8, 9, 10, 11) of a row (I, II, III) are disposed alternatingly in two parallel vertical planes extending parallel to the discharging direction of the filter cake.
